(19) United States
(12) Patent Application Publication
(10) Pub. No.: US 2007/0030897 A1
(43) Pub. Date: Feb. 8, 2007

(54) Encoding apparatus and method, recording apparatus and method, and decoding apparatus and method

(76) Inventor: Masahiro Ito, Tokyo (JP)

Correspondence Address: LOUIS WOO;LAW OFFICE OF LOUIS WOO, 717 NORTH FAYETTE STREET, ALEXANDRIA, VA, 22314, US

(21) Appl. No.: 10/572,410

(22) PCT Filed: Sep. 29, 2004
(86) PCT No.: PCT/JP04/14256

§ 371 Date: Mar. 16, 2006

(30) Foreign Application Priority Data
Sep. 29, 2003 (JP) 2003-338817

(51) Int. Cl. H04N 7/12

(52) U.S. Cl. 375/240.12; 375/240.26

(57) ABSTRACT

A new technique is disclosed, in which no freezing of image occurs even when time information becomes discontinuous as in the case of a jointed image-taking, and by which the image signal can be displayed without trouble before and after the jointed image-taking. According to this technique, an image encoding unit 1041 encodes an image signal by in-frame encoding and by inter-frame prediction encoding and generates an image encoding data. A time information (PCR) generating unit 10461 generates time information multiplexed in a transport stream. An identification information (jointed image-taking information) generating unit 10462 generates identification information to indicate that continuity of time information is interrupted when continuity of the time information multiplexed on the transport stream has been interrupted. A multiplexing unit 1047 multiplexes the image encoding data with the time information and the identification information and outputs it as a transport stream.

### TECHNICAL FIELD

The present invention relates to an encoding apparatus and a method for encoding and compressing an image signal by in-frame encoding and inter-frame prediction encoding. The invention also relates to a recording apparatus and a method for recording an image signal to a recording medium, and further, the invention relates to a decoding apparatus and a method for decoding the image signal encoded and compressed by in-frame encoding and inter-frame prediction encoding.

### BACKGROUND ART

As a method for compressing and encoding to reduce a coding amount of an image signal, an MPEG2 method is widely known. As the image data encoded and compressed by the MPEG2 method, there are three types: I picture encoded by in-frame encoding, and P picture and B picture encoded by inter-frame prediction encoding. A group of continuous pictures including at least one I picture is called GOP (Group Of Pictures).

An image data encoded by an MPEG encoder must be transferred to an MPEG decoder as an MPEG2-transport stream (hereinafter referred as “MPEG2-TS”). The MPEG decoder must decode the MPEG2-TS by synchronizing it with the MPEG encoder. In this respect, the MPEG encoder adds PCR (Program Clock Reference) to the MPEG2-TS as time stamp information (time information) and transfers it. The MPEG decoder decodes the image data and outputs an image signal decoded at display timing based on PCR.

Patent Document 1: Japanese Patent Application Publication 2003-230092

### DISCLOSURE OF THE INVENTION

Problems to be Solved by the Invention

As a recording apparatus (so-called video camera) for recording an image signal taken by a camera on a magnetic tape, a digital video camera is known, which uses a tape cassette of DV type and an image signal is recorded on the magnetic tape of the tape cassette by MPEG2 method.

In a video camera of this type, when a user performs jointed image-taking (stop-and-resume image-taking), PCR becomes discontinuous before and after the jointed image-taking when the image data is reproduced from the magnetic tape and the image data is encoded. As a result, the image signal decoded by the decoder cannot be displayed at correct display timing, and the freezing of image occurs. This problem is also described in the Patent Document 1.

To solve the above problem, it is an object of the present invention to provide an encoding apparatus and an encoding method, a recording apparatus and a recording method, and a decoding apparatus and a decoding method, in which no freezing of image occurs even when time information becomes discontinuous as in the case of jointed image-taking, and by which it is possible to display the image signal before and after the jointed image-taking without trouble.

Means for Solving the Problem

To solve the technical problems in the past as described above, the present invention provides an encoding apparatus for generating a transport stream by encoding an image signal, characterized by an image encoding unit for encoding said image signal by in-frame encoding and by inter-frame prediction encoding and for generating an image encoding data sorted in groups to GOP comprising a plurality of pictures, a time information generating unit for generating time information multiplexed in said transport stream, an identification information generating unit for generating identification information to indicate that continuity of time information is interrupted when the continuity of said time information multiplexed in said transport stream has been interrupted, and a multiplexing unit for multiplexing said image encoding data with said time information and said identification information and for outputting it as a transport stream.

Here, it is preferable that the multiplexing unit multiplexes said identification information on a part of bits of a private data, which is an adaptation field in a transport packet to make up said transport stream and which constitutes an optional field in said adaptation field.

Also, it is preferable that said multiplexing unit outputs a packet, which includes said identification information within a predetermined time period from the time when a packet including the leading byte of GOP has been outputted. Also, it is preferable that said predetermined time period is 3 milliseconds.

To solve the technical problems in the past as described above, the present invention provides an encoding method for generating a transport stream by encoding an image signal, characterized by encoding said image signal by in-frame encoding and by inter-frame prediction encoding, and generating an image encoding data sorted in groups to GOP comprising a plurality of pictures; generating time information multiplexed in said transport stream; generating identification information to indicate that continuity of time information is interrupted when continuity of said time information multiplexed in said transport stream has been interrupted; and multiplexing said image encoding data with said time information and said identification information, and outputting it as the transport stream.

Here, it is preferable that said identification information is multiplexed on a part of bits of a private data, which is an adaptation field in a transport packet to make up said transport stream and which constitutes an optional field in said adaptation field.

Also, it is preferable that a packet including said identification information within a predetermined time period from the time when a packet including the leading byte of GOP has been outputted. It is also preferable that said predetermined time period is 3 milliseconds.

Further, to solve the technical problems in the past as described above, the present invention provides a recording apparatus for recording an image signal to a recording medium, characterized by an image encoding unit for encoding said image signal by in-frame encoding and by inter-frame prediction encoding, and for generating an image encoding data sorted in groups to GOP comprising a plurality of pictures; a time information generating unit for generating time information to be recorded in said recording medium; an identification information generating unit for generating identification information to indicate that continuity of time information is interrupted when the continuity of the time information to be recorded in said recording medium has been interrupted; a multiplexing unit for multiplexing said image encoding data with said time information and said identification information and for outputting it as a transport stream; and a recording unit for sequentially recording said transport stream as tracks on said recording medium.

Here, it is preferable that the multiplexing unit multiplexes said identification information on a part of bits of a private data, which is an adaptation field in a transport packet to make up said transport stream and which constitutes an optional field in said adaptation field.

Also, it is preferable that said multiplexing unit outputs a packet, which includes said identification information within a predetermined time period from the time when a packet including the leading byte of GOP has been outputted. Also, it is preferable that said predetermined time period is 3 milliseconds.

Also, to solve the technical problems in the past as described above, the present invention provides a recording method for recording an image signal to a recording medium, characterized by encoding said image signal by in-frame encoding and by inter-frame prediction encoding and generating an image encoding data sorted in groups to GOP comprising a plurality of pictures, generating time information to be recorded in said recording medium, generating identification information to indicate that continuity of time information is interrupted when continuity of the time information to be recorded in said recording medium has been interrupted, multiplexing said image encoding data with said time information and said identification information and outputting as a transport stream, and sequentially recording said transport stream as tracks on said recording medium.

Here, it is preferable that said identification information is multiplexed on a part of bits of a private data, which is an adaptation field in a transport packet to make up said transport stream and which constitutes an optional field in said adaptation field.

Also, it is preferable that a packet including said identification information within a predetermined time period from the time when a packet including the leading byte of GOP has been outputted. It is also preferable that said predetermined time period is 3 milliseconds.

Further, to solve the technical problems in the past as described above, the present invention provides a decoding apparatus for decoding a transport stream multiplexed with an image encoding data, time information and identification information, said image encoding data being prepared by encoding an image signal by in-frame encoding and by inter-frame prediction encoding, and said identification information indicates that continuity of time information is interrupted when continuity of said time information has been interrupted, characterized by an image decoding unit for decoding said image decoding data and for outputting said image data, a storage unit for temporarily storing said image data, a time information reading unit for reading said time information; an identification information reading unit for reading said identification information, a display timing signal generating unit for generating a display timing signal of said image data by using said time information read by said time information reading unit when said identification information reading unit does not read said identification information, and for neglecting said time information read by said time information reading unit and for generating a display timing signal of said image data by using a predetermined timing signal, and a reading control unit for controlling the reading of said image data stored in said storage unit according to a display timing signal generated by said display timing signal generating unit.

Also, to solve the technical problems in the past as described above, the present invention provides a decoding method for decoding a transport stream multiplexed with an image encoding data, time information and identification information, said image encoding data being prepared by encoding an image signal by in-frame encoding and by inter-frame prediction encoding, and said identification information indicates that continuity of time information is interrupted when continuity of said time information has been interrupted, characterized by decoding said image encoding data and outputting an image data, temporarily storing said image data, reading said time information and reading said identification information, generating a display timing of said image data by using said time information as read when said identification information has not been read, and neglecting said time information as read and generating a display timing signal of said image data by using a predetermined timing signal when said identification information has been read, and controlling the reading of said image data as stored according to the generated display timing signal.

Advantageous Effects of the Invention

According to the present invention, no freezing of image occurs even when the jointed image-taking is performed and the image signal can be displayed without trouble before and after the jointed image-taking.

### BRIEF DESCRIPTION OF THE DRAWINGS

FIG. 1 A block diagram showing an embodiment of an encoding apparatus, a recording apparatus and a decoding apparatus of the present invention.

FIG. 2 A drawing explaining for jointed image-taking.

FIG. 3 A drawing explaining for jointed image-taking.

FIG. 4 A block diagram showing a detailed embodiment of an encoding apparatus of the present invention.

FIG. 5 A drawing showing an MPEG2-transport stream.

FIG. 6 A drawing showing an example of recording pattern on a magnetic tape when the jointed image-taking is performed.

FIG. 7 A block diagram showing a detailed aspect of the decoding apparatus of the present invention.

FIG. 8 A block diagram showing an example of a concrete arrangement of an IEEE1394 interface 112 shown in FIG. 1.

FIG. 9 A drawing explaining transfer of AV data via the IEEE1394 interface 112.

### BEST MODE FOR CARRYING OUT THE INVENTION

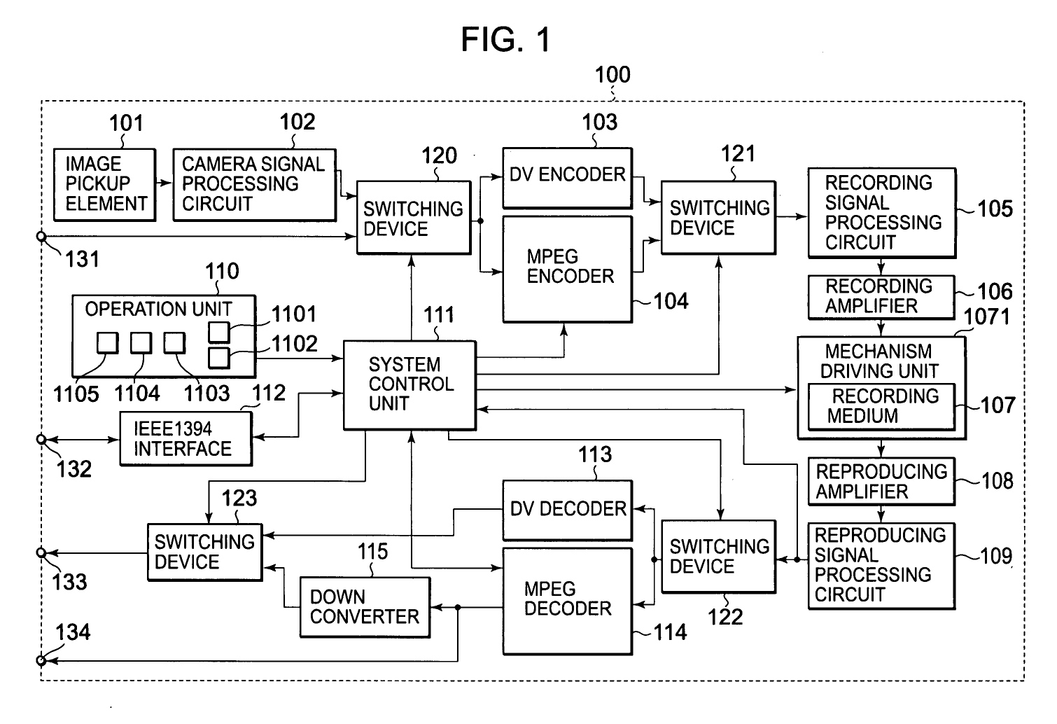

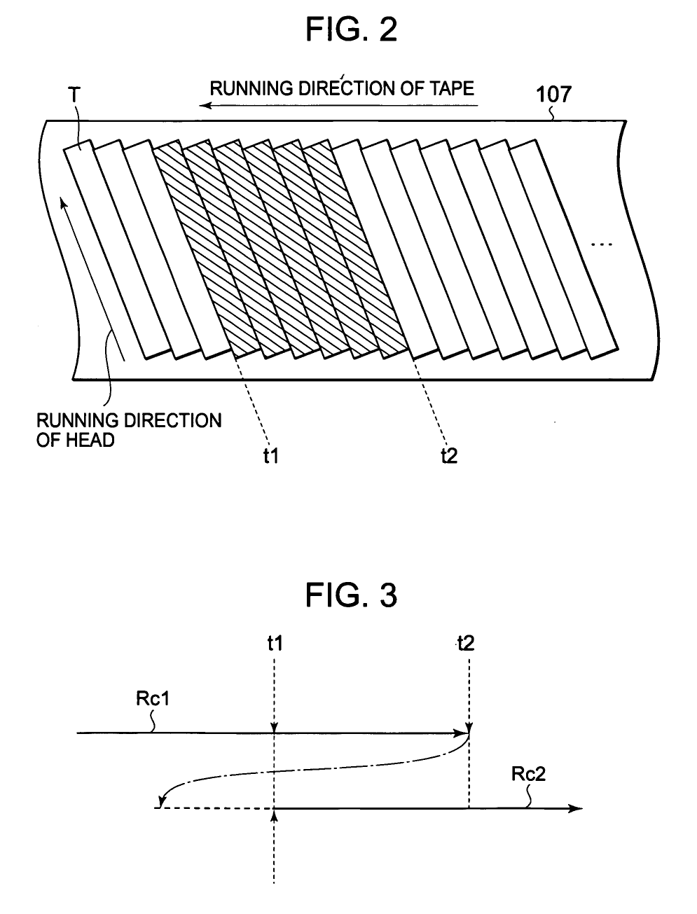

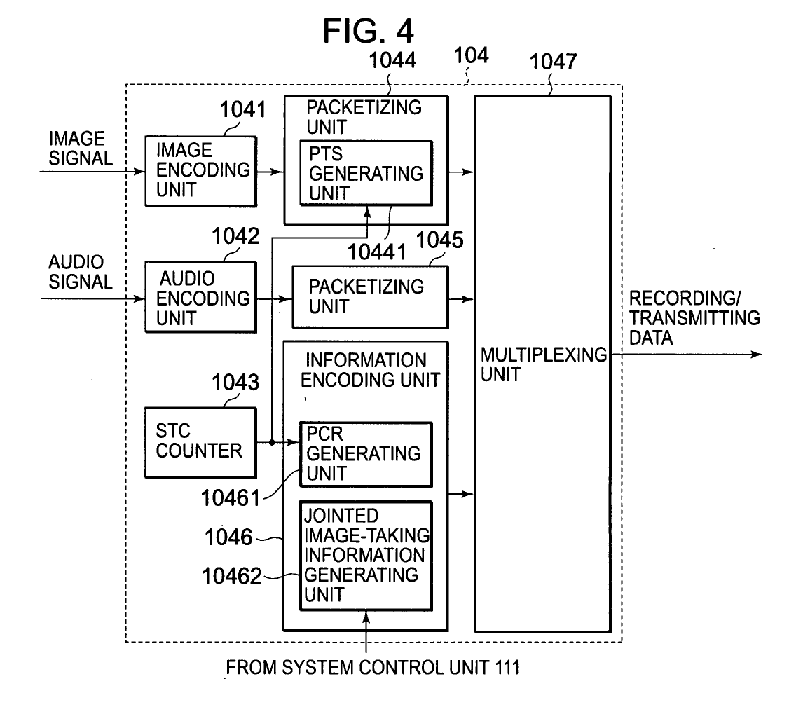

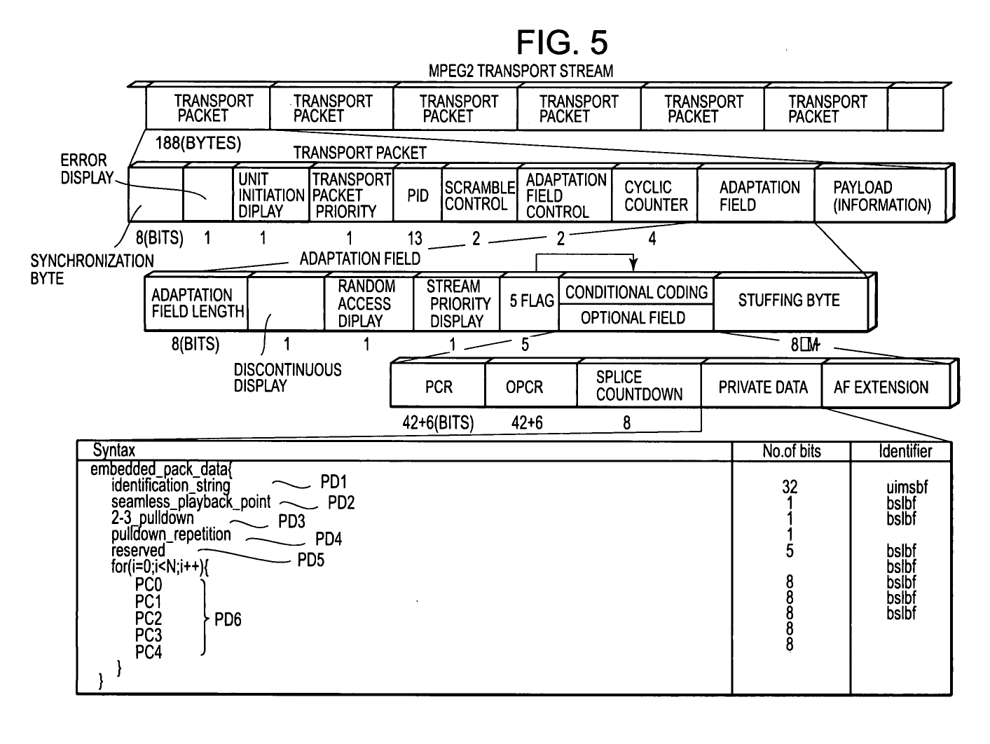

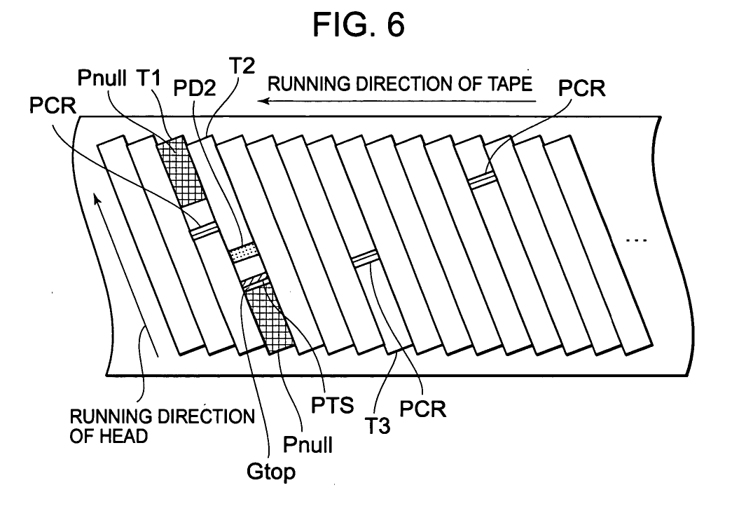

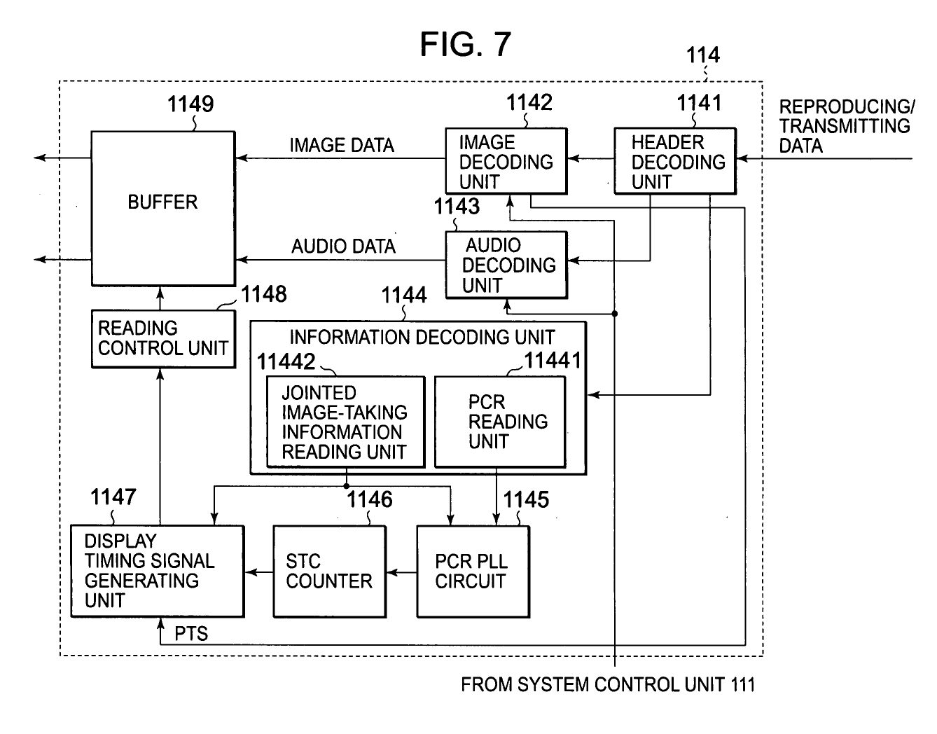

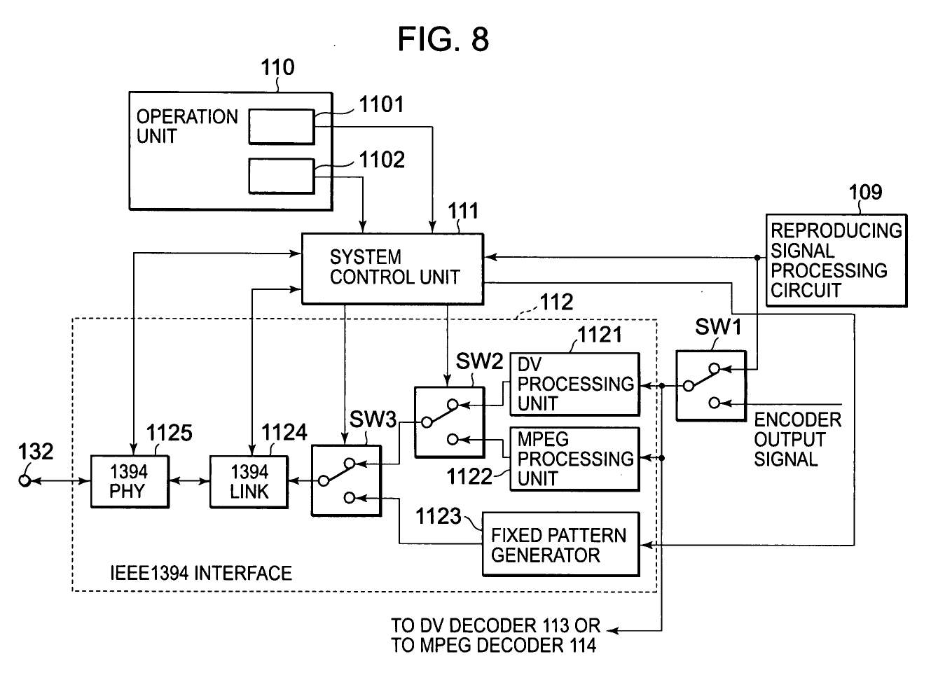

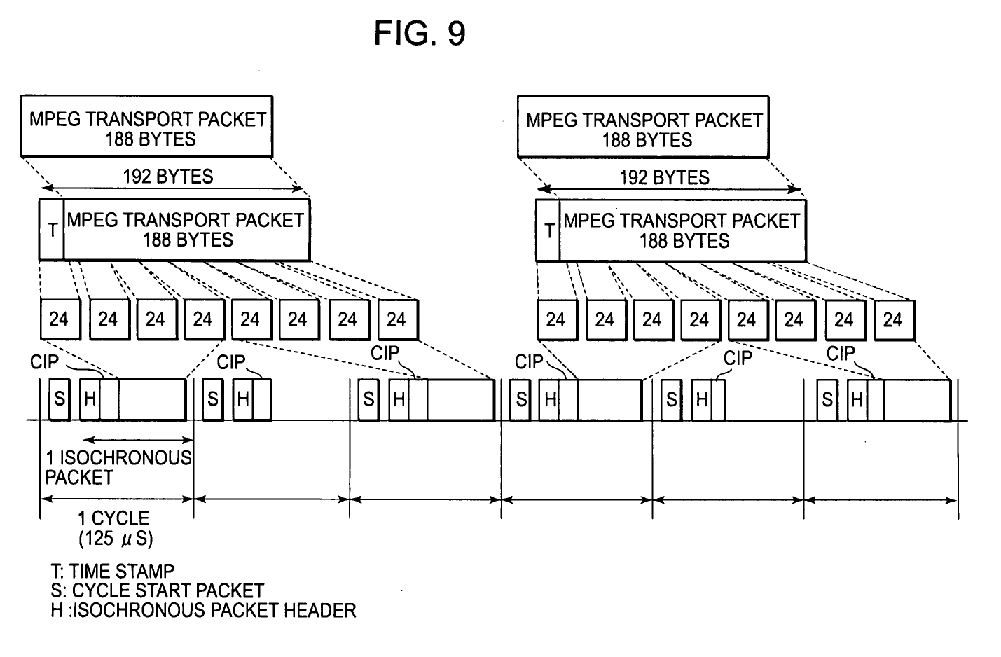

Description will be given below on an encoding apparatus and an encoding method, a recording apparatus and a recording method, and a decoding apparatus and a decoding method according to the present invention. FIG. 1 is a block diagram to show an aspect of an encoding apparatus, a recording apparatus and a decoding apparatus of the present invention. FIG. 2 and FIG. 3 each represents a drawing to explain jointed image-taking. FIG. 4 is a block diagram to show a detailed embodiment of an encoding apparatus of the present invention. FIG. 5 represents a drawing and a table to show an MPEG2-transport stream. FIG. 6 is a drawing to show an example of recording pattern on a magnetic tape when the jointed image-taking is performed. FIG. 7 is a block diagram of a detailed aspect of the decoding apparatus of the present invention. FIG. 8 is a block diagram to show an example of a concrete arrangement of an IEEE1394 interface 112 shown in FIG. 1, and FIG. 9 is a drawing to explain transfer of AV data via the IEEE1394 interface 112.

A recording apparatus 100 of an aspect of the invention shown in FIG. 1 complies with the provisions as set forth in the HD Digital VCR Conference, and it is an example of a video camera, by which it can be selected whether to record and reproduce a standard (SD) signal such as NTSC signal by DV method, or to record and reproduce high definition (HD) signal by MPEG2 method. The HD signal is defined as a progressive signal (720P) including 720 valid scan lines or an interlace signal (1080i) including 1080 valid scan lines.

In FIG. 1, an image to be taken (an optical signal) coming through a lens (not shown) is converted to an image pickup signal (an electric signal) by an image pickup element 101 and is shaped to an image signal at a camera signal processing circuit 102. The image signal outputted from the camera signal processing circuit 102 and the image signal supplied from an external signal. input terminal 131 are inputted to a switching device 120. The switching device 120 sends the image signal to a DV encoder 103 and an MPEG encoder 104. Naturally, the image signal may not be supplied from the external signal input terminal 131.

The DV encoder 103 encodes the inputted image signal by DV encoding. The MPEG encoder 104 encodes the inputted image signal by MPEG2 encoding. A DV encoding data outputted from the DV encoder 103 and an MPEG 2 encoding data outputted from the MPEG encoder 104 are inputted to a switching device 121.

An operation unit 110 is provided with a recording mode selecting button 1101 for selecting whether the image signal is to be recorded to a recording medium 107 (serving as a tape cassette of DV type) in DV format or it is to be recorded by MPEG2 method. A system control unit 111 controls the switching device 121 depending on the selection by the recording mode selecting button 1101, and the switching device 121 supplies either the DV encoding data from the DV encoder 103 or the MPEG 2 encoding data from the MPEG encoder 104 to the recording signal processing circuit 105. Detailed description will be given later on concrete arrangement and operation of the MPEG encoder 104, which is an aspect of the encoding apparatus of the present invention.

The recording signal processing circuit 105 performs mapping on the DV encoding data or the MPEG encoding data, adds various types of identification data and supplies it to a recording amplifier 106. The recording amplifier 106 amplifies the inputted data and supplies it to a mechanism driving unit 1071 including a recording head. In addition to a recording head and a reproducing head provided on a rotating drum, the mechanism driving unit 1071 further comprises a loading mechanism and a running mechanism. The loading mechanism picks up a magnetic tape of the recording medium 107 from a tape cassette, and the running mechanism is to run the magnetic tape. As a mechanism driving unit 1071, a mechanism already known can be adopted, and detailed description on the arrangement and on the operation is not given here.

The DV encoding data or the MPEG2 encoding data added with various types of identification data as described above is recorded on the recording medium 107.

Here, description will be given on the jointed image-taking (stop-and-resume image-taking) referring to FIG. 2 and FIG. 3. The jointed image-taking of the image signal is to stop the recording on the recording medium 107 for once and to resume the recording. In the stop of the recording, both the so-called record posing state and complete stop of recording are included. When a user presses a record starting button 1103 on the operation unit 110 shown in FIG. 1, the recording apparatus 100 starts recording. On the recording medium 107, tracks tilted with respect to the running direction of the recording medium (magnetic tape) 107 are formed one after another as shown in FIG. 2. If the user presses a temporary recording stop button 1104 on the operation unit 110 at a time t1, the recording is actually stopped for once at a time t2. Here, it is supposed that recording from the pressing of the temporary recording stop button 1104 to the stop of the recording at the time t2 is Rc1 as shown in FIG. 3. Then, the interval between the time t1 and the time t2 is about 1 second.

When the user presses the recording start button 1103 again, the recording medium 107 is unwound for a time interval of about 2 seconds. As shown by a broken line in FIG. 3, reproducing operation is performed up to the position of the track near the time t1 when instruction is given to stop the recording in the recording Rc1, and a new recording Rc2 is started from the track position near the time t1. In the case of the recording of the MPEG encoding data, the new recording Rc2 is started from the leading head of GOP at the track near the time t1. The time t1, at which an instruction to stop the recording has been given, is stored in a system control unit 111, and the jointed image-taking as described above is carried out by using the time t1. As shown by hatching in FIG. 2, the recording Rc1 as recorded for once is erased by an erasing head for about 1 second between the time t1 and the time t2, and the recording Rc2 is overwritten.

As described above, the MPEG2 transport stream (MPEG2-TS) comprising the MPEG2 encoding data contains PCR, which is time information. PCR is continuous during the time period of the recording Rc1, while PCR becomes discontinuous when the recording is shifted from Rc1 to Rc2. This discontinuation of PCR causes trouble in decoding (reproducing) operation as described later, and the freezing of image occurs.

This problem occurs—not only when the recording is stopped and then it is resumed after the recording has been started by the user as described above—but also when the image is recorded newly at the middle of the recording medium 107 where data has been already recorded.

Next, description will be given on an arrangement of the MPEG encoder 104 shown in FIG. 1 referring to FIG. 4. In FIG. 4, processing of an audio (voice) signal is also shown, which is not given in FIG. 1. In FIG. 4, an image signal is encoded to an I picture compressed within a frame and a P picture and a B picture compressed between frames by an image encoding unit 1041. The image encoding unit 1041 outputs an image encoding data sorted in groups to GOP, which comprises a plurality of pictures. The audio signal is encoded by an audio encoding unit 1042. An STC counter 1043 is a counter driven by STC (System Time Clock).

A packetizing unit 1044 packetizes the image encoding data outputted from the image encoding unit 1041 and supplies it to a multiplexing unit 1047. The packetizing unit 1044 is provided with a PTS generating unit 10441, and the PTS generating unit 10441 generates PTS (Presentation Time Stamp). The encoding data outputted from the image encoding unit 1041 belongs to ES type, and output of the packetizing unit 1044 belongs to PES type. The packetizing unit 1045 packetizes the audio encoding data outputted from the audio encoding unit 1042 and supplies it to the multiplexing unit 1047.

An information encoding unit 1046 comprises a PCR generating unit 10461 and a jointed image-taking information generating unit 10462. The PCR generating unit 10461 generates PCR. The jointed image-taking information generating unit 10462 generates a jointed image-taking information packet in response to a control signal, which indicates an instruction for jointed image-taking from the system control unit 111. In addition to the PCR and the jointed image-taking information packet, the information encoding unit 1046 also generates PAT (Program Association Table) and PMT (Program Map Table). These types of control information are supplied to the multiplexing unit 1047. Format of the MPEG2-TS outputted from the multiplexing unit 1047 is as shown in FIG. 5.

As shown in FIG. 5, it is defined that the MPEG2-TS is multiplexed and separated by a fixed length transport packet of 188 bytes. Each transport packet comprises headers from synchronization byte to adaptation field and a payload, which is actual information of image data and audio data. In addition to the synchronization byte and adaptation field, the header comprises PID (Packet ID), scramble control information, adaptation field control information, etc. The adaptation field control information has 2 bits showing whether the adaptation field is present or not and whether the payload is present or not. Although not shown here, the payload comprises PTS.

Information relating to PCR and stuffing byte (invalid data byte) can be optionally included in the adaptation field. The adaptation field comprises an adaptation field length field, a discontinuous display field, an optional field, etc. The optional field comprises PCR, original PCR (OPCR), and private data.

In the present embodiment, the private data is defined as given below to identify whether the jointed image-taking is present or not. More concretely, the private data is defined as follows: 32-bit ID string information PD1, 1-bit seamless reproducing point information PD2, 1-bit 2-3 pulldown information PD3, 1-bit pulldown repeat information PD4, 5-bit hold information PD5, and 5 PC data PD6, each comprising 8-bit PC0 to PC4.

The ID string information is information that the private data has a structure as defined in the above. The 2-3 pulldown information is information to indicate that an image signal of 24P (progressive with 24 frames) is converted to 60P (progressive with 60 frames) by 2-3 pulldown. The pulldown repeat information is information to indicate as to by which kind of pattern the 2-3 pulldown is repeated. PC data comprising PC0 to PC4 is additional information such as date information in DV format, time code, discriminant flag such as SD/HD. By defining additional information in DV format as PC data, the recording apparatus 100 can record the same information as additional information of DV format even when recording and reproduction are performed by MPEG2 method.

In the present embodiment, “1” is generated during continuous image-taking as seamless reproducing point information, and “0” is generated in the other cases, e.g. when the jointed image-taking is performed. As already described, the jointed image-taking information generating unit 10462 converts the seamless reproducing point information from “1” to “0” in response to a control signal to indicate the instruction of the jointed image taking from the system control unit 111 and generates the jointed image-taking information packet. As a part of PID of the transport packet, a predetermined value is set to PID of the jointed image-taking information packet (i.e. a packet including PD1 to PD6).

In the meantime, when the MPEG2-TS including the image encoding data sorted in groups to GOP, which comprises a plurality of pictures, is outputted, the MPEG encoder 104 (multiplexing unit 1047) outputs the jointed image-taking information packet within a predetermined time period from the time when the packet has been outputted including the leading byte of GOP. This predetermined time period is preferably 3 milliseconds. That is, the time interval between output time of the packet including the leading byte of GOP and the output time of the jointed image-taking information packet is set to within 3 milliseconds.

The MPEG2-TS as described above is recorded in the recording medium 107 as shown in FIG. 6. In FIG. 6, tracks up to the track T1 belong to one GOP, and a new GOP begins from the track t2. The GOP up to the track T1 corresponds to the recording Rc1 in FIG. 3, and the GOP from the track T2 corresponds to the recording Rc2 in FIG. 3. As shown in FIG. 6, a portion from a terminal end of the track T1, which is the final track of GOP, to a starting end of the track T2, which is the first track of GOP), is indicated as a null packet Pnull. Here, it is defined as a null packet Pnull, while it may include an audio packet in addition to the null packet. GOP in the track T2 is initiated from the leading Gtop.

As shown in FIG. 6, PCR is recorded at a plurality of points within one GOP, and PTS is recorded at the top of one GOP. PCR in the track T1 shown in FIG. 6 is discontinuous to PCR in the track T3.

As described above, the MPEG encoder 104 outputs the jointed image-taking information packet within a predetermined time period from the time when the packet including the leading byte of GOP has been outputted. Thus, the seamless reproducing point information PD2 is recorded near the leading Gtop of the GOP taken by the jointed image-taking. To facilitate the explanation, the seamless reproducing point information PD2 is described as having a predetermined area in FIG. 6. However, generation time of the stream from the MPEG encoder 104 does not necessarily concur with recording time to the recording medium 107. Thus, the jointed image-making information packet is not always recorded within a predetermined time period from the leading Gtop of GOP.

When the image signal is recorded in NTSC mode with 525 scan lines and 60 fields in DV format, 1 frame comprises 10 tracks. When recording is performed in the MPEG2 mode, the number of tracks in one frame is variable.

Turning back to FIG. 1, description will be given now on the reproduction of the recording medium 107. When the user presses a reproduction button 1105 in the operation unit 110 shown in FIG. 1, a reproduction signal reproduced by the recording medium 107 is amplified by a reproduction amplifier 108 and is inputted to a reproduction signal processing circuit 109. The reproduction signal is shaped to an encoding data by the reproduction signal processing circuit 109, and this is supplied to the system control unit 111 and to a switching device 122. Based on the inputted data, the system control unit 111 identifies whether the reproduction signal is a signal of DV mode or a signal of MPEG2 mode. Depending on the identified result, the system control unit 111 performs the switching by the switching devices 122 and 123.

If the reproduction signal is a signal of DV mode, the switching device 122 supplies the DV encoding data from the reproduction signal processing circuit 109 to the DV decoder 113. If the reproduction signal is a signal of MPEG2 mode, the MPEG2 encoding data from the reproduction signal processing circuit 109 is supplied to the MPEG decoder 114.

The DV decoder 113 decodes the inputted DV encoding data and supplies it to the switching device 123. The MPEG decoder 114 decodes the inputted MPEG2 encoding data and supplies it to a down converter 115 and to an HD signal output terminal 134. The down converter 115 converts HD signal to SD signal and supplies it to the switching device 123. Under the control of the system control unit 111, the switching device 123 sends either an image signal outputted from the DV decoder 113 or an image signal outputted from the down converter 115 to the SD signal output terminal 133. The image signal of SD signal is outputted from the SD signal output terminal 133, and the image signal of HD signal is outputted from the HD signal output terminal 134.

Next, description will be given on an arrangement example of the MPEG decoder 114 shown in FIG. 1 referring to FIG. 7. In FIG. 7, processing of an audio (voice) signal not shown in FIG. 1 is given. In FIG. 7, the MPEG2 encoding data, which is also a reproduction/transmission data, is inputted to a header decoding unit 1141, and the header of the MPEG2-TS as explained in connection with FIG. 5 is decoded. Based on the result of the decoding of the header at the header decoding unit 1141, a video packet included in the payload of the MPEG2-TS is sent to an image decoding unit 1142. An audio packet is sent to an audio decoding unit 1143. Various types of control information including PCR, jointed image-taking information packet, PAT and PMT are sent to an information decoding unit 1144.

Based on the control by the system control unit 111, the image decoding unit 1142 decodes the video packet and outputs PTS. Based on the control by the system control unit 111, the audio decoding unit 1143 decodes the audio packet.

The information decoding unit 1144 comprises a PCR reading unit 11441 and a jointed image-taking information reading unit 11442. The PCR reading unit 11441 extracts PCR included in the above control information and sends it to PCRPLL (PCR Phase Locked Loop) circuit 1145. Based on the inputted PCR, the PCRPLL circuit 1145 generates a clock (STC) of 27 MHz and sends it to an STC counter 1146. In normal state as to be described later, the STC counter 1146 generates an STC counter value according to the clock of 27 MHz as inputted and sends it to a display timing signal generating unit 1147.

The jointed image-taking information reading unit 11442 extracts the jointed image-taking information packet included in the above control information and sends a signal “1” or “0” of the seamless reproducing point information PD2 to the PCRPLL circuit 1145 and to the display timing signal generating unit 1147. PTS outputted from the image decoding unit 1142 is also inputted to the display timing signal generating unit 1147.

The STC counter 1146 and the display timing signal generating unit 1147 are in the case where the seamless reproducing point information PD2 is “1”, i.e. the case where a recording signal recorded from continuous image-taking is reproduced. It is in normal state where continuous PCR is reproduced and the case where the seamless reproducing point information PD2 is “0”, i.e. the case where the recording signal recorded by the jointed image-taking is reproduced. Thus, operation is different from non-normal state where discontinuous PCR is reproduced.

First, in normal state, based on STC inputted from the PCRPLL circuit 1145, the STC counter 1146 generates an STC counter value. The display timing signal generating unit 1147 generates a display timing signal when PTS sent from the image decoding unit 1142 concurs with the STC counter value sent from the STC counter 1146.

Next, in non-normal state, the PCRPLL circuit 1145 neglects the PCR inputted from the PCR reading unit 11441 and generates a free-run STC. The display timing signal generating unit 1147 generates a display timing signal with a predetermined fixed interval regardless of whether PTS concurs with the STC counter value or not. The predetermined fixed interval is a frame frequency of HD signal, i.e. a time interval of 30 Hz or 60 Hz.

The image data outputted from the image decoding unit 1142 and an audio data outputted from the audio decoding unit 1143 are written in a buffer 1149 for once. A reading control unit 1148 controls in such manner that the image data stored in the buffer 1149 is read when the display timing signal is inputted from the display timing signal generating unit 1147. Although it is not described in detail here, the audio data is read from the buffer 1149 when the output timing signal generated according to PTS for audio data has been inputted to the reading control unit 1148.

When a predetermined time has elapsed after the seamless reproducing point information PD2 is changed from “0” to “1”, the PCRPLL circuit 1145 generates a stable clock of 27 MHz according to a new PCR after the jointed image-taking. Then, the STC counter 1146 and the display timing signal generating unit 1147 return to operation in the normal state.

As described above, when PCR is turned to discontinuous, the PCRPLL circuit 1145 neglects PCR inputted from the PCR reading unit 11441 and generates a free-run STC, and the display timing signal generating unit 1147 generates a display timing signal with a predetermined fixed interval. Thus, the freezing of the image does not occur after the jointed image-taking, and it is possible to display the image signal without trouble before and after the jointed image-taking.

Next, description will be given on the operation of an IEEE1394 interface 112 and the output of a digital image data and an audio data (hereinafter referred as digital AV data) referring to FIG. 8 and FIG. 9.

As shown in FIG. 8, based on the control by the system control unit 111, a switch SW1 switches over the reproduction signal processing circuit 109 and an encoder output signal from the DV encoder 103 or the MPEG encoder 104. In FIG. 1, the switch SW1 is not shown. Either the output of the reproduction signal processing circuit 109 or the encoder output signal is supplied to the IEEE1394 interface 112 and to the DV decoder 113 or to the MPEG decoder 114.

The IEEE1394 interface 112 comprises a DV processing unit 1121, an MPEG processing unit 1122, a fixed pattern generator 1123, a 1394LINK 1124, a 1394PHY 1125 and switches SW2 and SW3. To transfer the digital AV data, which is a DV encoding data, the DV processing unit 1121 adds additional information such as CIP (Common Isochronous Packet) header and the like and performs division mapping to divide to packets suitable for transfer. Similarly, the MPEG processing unit 1122 adds additional information such as CIP header in order to transfer the digital AV data, i.e. MPEG2 encoding data, and performs division mapping to divide to packets suitable for transfer.

The operation unit 110 comprises an output mode selecting button 1102. By the output mode selecting button 1102, it is possible to switch over to DV selection, MPEG selection or automatic selection. When transfer mode for output switching is different between the digital AV data to be recorded or reproduced and the output switching by the output mode selecting button 1102, a fixed dummy data is generated by fixed pattern generator 1123, and this is added to the digital AV data.

The 1394LINK 1124 is a link layer where the type of the packets to be transferred on IEEE1394 bus and the method of error checking are defined. The 1394PHY 1125 is a physical layer where encoding system of serial signal, electrical specification of bus, and mediating procedure when bus is used are determined. The switch SW2 switches over and issues the output of the DV processing unit 1121 and the output of the MPEG processing unit 1122. The switch SW3 switches over and issues the output of the switch SW2 and the output of a fixed pattern generator 1123.

When the DV encoding data is transferred via the IEEE1394 interface 112, an AV/C protocol is used. The AV/C protocol defines data structure when AV data is sent by isochronous transfer via the IEEE1394 interface. CIP header and real time AV data are stored in data field of isochronous packet, and isochronous transfer is carried out.

In DV standards, image data or audio data is transferred as data block of 80 bytes called “DIF block”, and 6 DIF blocks (480 bytes) are transferred in one isochronous packet. Data for one track of DV digital video is transferred as a total of 150 DIF blocks including one header block, 135 video data blocks, 9 audio blocks, 3 video AUX data blocks, and 2 sub-code data blocks. Namely, it corresponds to 25 packets of isochronous transfer. In case of NTSC, one video frame comprises 10 tracks. Thus, video data of one frame comprises 250 isochronous packets, and 30 frames of video data comprise 7500 isochronous packets. In the isochronous transfer, 1 cycle consists of 125 μs. Because there are 8000 cycles in one second, the DV mode data can be transferred at real time.

On the other hand, when the MPEG2 encoding data (MPEG2-TS) is transferred via the IEEE1394 interface 112, the AV/C protocol is used similarly for the transfer of DV mode data. In MPEG, it is defined that data type to transmit or receive the encoded data stream comprises a transport packet of 188 bytes. By this packet, image data and audio data are multiplexed.

As already described, MPEG2-TS comprises PCR, and PCR is generated from a system clock of 27 MHz used in the encoder. On the receiving side to receive the MPEG2-TS, the counter value of the system clock on the receiving side is corrected according to PCR. If variation occurs in delay time when the data is received, the system clock on the receiving side may change and this may cause trouble on display. In this respect, when a packet of the MPEG2-TS (MPEG transport packet) is transferred via the IEEE1394 interface 112, consideration must be given on the maximum delay time during the transmission, and transmission is performed by adding 4-bytes time stamp on the transmitting side. On the receiving side, based on the added time stamp, the timing of decoding of the MPEG transport packet is managed according to the added time stamp, and variation of the delay time is corrected.

In the isochronous transfer via the IEEE1394 interface, the size of the data to be transmitted in one cycle is fixed for the purpose of keeping the data transfer speed. Thus, to transfer the MPEG transport packet at optimal transfer speed, the time stamp of 4 bytes as described above is added to the MPEG transport packet of 188 bytes. The packet of 192 bytes thus added is split into 24-bytes units and are transferred. When a 24-bytes packet is transferred in one cycle via isochronous transfer, the transfer speed is 1.536 Mbps (24 bytes×8000 cycles×8 bits). This is an optimal minimal byte unit to transfer the MPEG data with an encoding speed of 1.5 Mbps or more.

Referring to FIG. 9, description will be given now on a case of animation transfer by MPEG2 with an encoding speed of 4 Mbps. As shown in FIG. 9, the number of data blocks included in the payload of one isochronous packet is set to four using the packet divided to 24 bytes as a unit. As a result, the transfer speed is maintained at 6.144 Mbps. Before the data block transferred in one isochronous packet, CIP header information as defined in AV/C protocol is added. In this header information, the type of data, number of divisions of transport packet, data block number, size of data block, etc. are stored. In case there is no data block to be sent depending on the condition of the image to be encoded, a dummy packet added only with CIP header is transmitted.

Upon receipt of this isochronous packet via the IEEE1394 interface, the external decoder neglects PCR before the jointed image-taking information packet on the stream and decodes the stream according to a display timing signal with a predetermined time interval. As a result, even when the user stops and resumes the image-taking, i.e. if the user performs the so-called jointed image-taking, the freezing of the image does not occur after the jointed image-taking, and it is possible to display the image signal without trouble before and after the jointed image-taking.

### INDUSTRIAL APPLICABILITY

According to the present invention, when a transport stream with discontinuous time information is recorded and reproduced or when a transport stream with discontinuous time information is inputted from an external device (external encoding apparatus) via an interface such as the IEEE1394 interface and is reproduced, no freezing of image occurs on a portion where the time information is discontinuous, and the image signal can be displayed without trouble and difficulty before and after the portion where the time information is discontinuous.

Also, when the transport stream with discontinuous time information is sent to an external device (external decoding apparatus) via an interface such as the IEEE1394 interface and is reproduced by the external device, no freezing of image occurs on a portion where the time information is discontinuous, and the image signal can be displayed without trouble and difficulty before and after the portion where the time information is discontinuous.

1-16. (canceled)

17. A decoding apparatus comprising:
a reproducing unit for reproducing a transport stream recorded on a recording medium in such a manner that an image encoding data prepared by encoding an image signal by in-frame encoding and by inter-frame prediction encoding, time information and identification information indicating that continuity of said time information is interrupted are multiplexed, said identification information being generated when continuity of said time information has been interrupted;
an image decoding unit for decoding said image decoding data contained in a reproduction signal reproduced by said reproducing unit and for outputting said image data;
a storage unit for temporarily storing said image data;
a time information reading unit for reading said time information contained in said reproduction signal reproduced by said reproducing unit;
an identification information reading unit for reading said identification information contained in said reproduction signal reproduced by said reproducing unit;
a display timing signal generating unit for generating a display timing signal of said image data by using said time information read by said time information reading unit when said identification information reading unit does not read said identification information, and for neglecting said time information read by said time information reading unit and for generating a display timing signal of said image data by using a predetermined timing signal; and
a reading control unit for controlling the reading of said image data stored in said storage unit according to a display timing signal generated by said display timing signal generating unit.

18. A decoding method comprising:
generating a reproduction signal by reproducing a transport stream recorded on a recording medium in such a manner that an image encoding data prepared by encoding an image signal by in-frame encoding and by inter-frame prediction encoding, time information and identification information indicating that continuity of said time information is interrupted are multiplexed, said identification information being generated when continuity of said time information has been interrupted;
decoding said image encoding data contained in said reproduction signal and outputting an image data;
temporarily storing said image data;
reading said time information contained in said reproduction signal;
reading said identification information contained in said reproduction signal;
generating a display timing of said image data by using said time information as read when said identification information has not been read, and neglected said time information as read and generating a display timing signal of said image data by using a predetermined timing signal when said identification information has been read; and
controlling the reading of said image data as stored according to the generated display timing signal.

19. The decoding apparatus according to claim 17, wherein said identification information reading unit is arranged to read said identification information multiplexed with a part of bits of a private data, constituting an optional field within an adaptation field which is within a transport packet making up said transport stream.

20. The decoding method according to claim 18, wherein a process for reading said identification information is a process for reading said identification information multiplexed with a part of bits of a private data, constituting an optional field within an adaptation field which is within a transport packet making up said transport stream.
